(19) United States
(12) Patent Application Publication
(10) Pub. No.: US 2013/0002419 A1
(43) Pub. Date: Jan. 3, 2013

(54) CAR DOOR WARNING SYSTEM

(76) Inventor: YU-TUAN LEE, Taipei City (TW)

(21) Appl. No.: 13/527,349

(22) Filed: Jun. 19, 2012

(30) Foreign Application Priority Data
Jun. 28, 2011 (TW) 100122705

(51) Int. Cl. B60Q 1/00

(52) U.S. Cl. 340/457

(57) ABSTRACT

A car door warning system includes a sensing unit, a control unit and a warning unit. The sensing unit is disposed at a door handle of at least one car door. When the door handle is approached or touched by an object, the sensing unit generates a sensing signal before the door handle is moved. The control unit receives the sensing signal and generates a control signal. The warning unit receives the control signal and generates a warning signal. The car door warning system can send out a warning signal in advance before the door handle is moved or before the car door is opened, and can prevent accidents while the car door is opened.

### CROSS REFERENCE TO RELATED APPLICATIONS

This Non-provisional application claims priority under 35 U.S.C. §119(a) on Patent Application No(s). 100122705 filed in Taiwan, Republic of China on Jun. 28, 2011, the entire contents of which are hereby incorporated by reference.

### BACKGROUND OF THE INVENTION

1. Field of Invention

The present invention relates to a warning system and, in particular, to a car door warning system.

2. Related Art

FIG. 1 is a block diagram showing a conventional car door warning system 1. The car door warning system 1 includes a motion detector 11 for detecting whether the door handle is pulled or the door is opened, a control unit 12, and a warning device 13. The control unit 12 is electrically connected with the motion detector 11 and the warning device 13. When the door handle is pulled or the door is opened, the motion detector 11 can immediately detect it and output a detecting signal T. The control unit 12 receives the detecting signal T and outputs an enabling signal V accordingly. The enabling signal V then enables the warning device 13 to generate a warning signal by light or sound.

As mentioned above, the warning device 13 of the car door warning system 1 is enabled after the door handle is pulled or the car door is opened. However, as the door handle is pulled, the car door is usually opened at the same time, which may cause some unpredictable accidents. For example, if someone (child) sitting on the rear seat suddenly opens the car door, the following car or motorcycle or the pedestrian may directly hit on the opened door in accident. In other words, the conventional car door warning system 1 can not perfectly alert the drivers or passengers before the door handle is pulled or the car door is opened.

Therefore, it is an important subject of the present invention to provide a car door warning system that can alert the user before the door handle is pulled or the car door is opened, thereby preventing the accident caused by the opened door.

### SUMMARY OF THE INVENTION

In view of the foregoing subject, an objective of the present invention is to provide a car door warning system that can alert the user before the door handle is pulled or the car door is opened, thereby preventing the accident caused by the opened door.

To achieve the above objective, the present invention discloses a car door warning system including a sensing unit, a control unit and a warning unit. The sensing unit is disposed at a door handle of at least one car door. When the door handle is approached or touched by an object, the sensing unit generates a sensing signal before the door handle is moved. The control unit receives the sensing signal and generates a control signal, preferably, according to a lock status of the car door. The warning unit receives the control signal and generates a warning signal.

In one embodiment of the invention, the sensing unit comprises an electronic sensor, a touch sensor, an IR (infrared-ray) sensor, a supersonic sensor, a pressure sensor, a micro switch (miniature snap-action switch), a proximity sensor, or their combinations.

In one embodiment of the invention, the warning signal comprises sound, voice message, light or their combinations.

In one embodiment of the invention, the control unit further comprises an input terminal for receiving a status signal.

In one embodiment of the invention, the control unit further comprises an output terminal for outputting a lock control signal.

As mentioned above, the car door warning system of the invention has a sensing unit disposed at a door handle of at least one car door for generating a sensing signal when the door handle is approached or touched by an object and before the door handle is moved. In addition, the control unit receives the sensing signal and generates a control signal, preferably, according to a lock status of the car door, and the warning unit generates a warning signal after receiving the control signal. Accordingly, before the door handle is moved or the car door is opened, it is possible to alert the driver or passengers that an object approaches or touches the door handle, thereby preventing the accident caused by opened car door.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a block diagram showing a conventional car door warning system;

FIG. 2 is a block diagram of a car door warning system according to an embodiment of the present invention; and

FIG. 3 is a block diagram of another car door warning system according to the embodiment of the present invention.

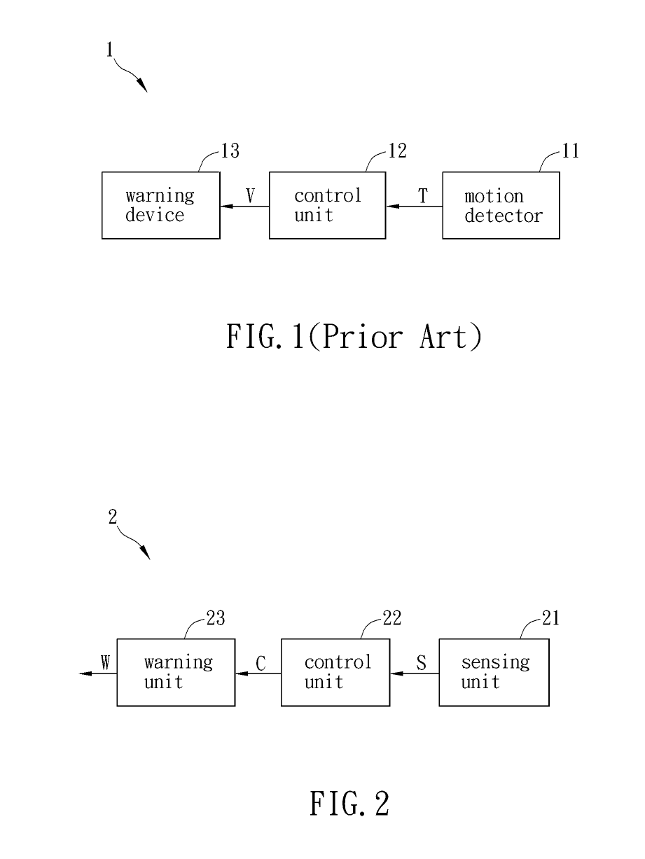

### DETAILED DESCRIPTION OF THE INVENTION

The present invention will be apparent from the following detailed description, which proceeds with reference to the accompanying drawings, wherein the same references relate to the same elements.

FIG. 2 is a block diagram of a car door warning system 2 according to an embodiment of the present invention. With reference to FIG. 2, the car door warning system 2 includes a sensing unit 21, a control unit 22 and a warning unit 23.

The sensing unit 21 is disposed at a door handle of at least one car door. In this case, the sensing unit 21 can be disposed at the interior or exterior door handle, and it can be an electronic sensor, a touch sensor, an IR (infrared-ray) sensor, a supersonic sensor, a pressure sensor, a micro switch (miniature snap-action switch), a proximity sensor, or their combinations. The IR sensor, supersonic sensor, proximity sensor and electronic sensor for sensing the variation of electric or magnetic field are non-contact sensing components, which can generate the sensing signal S as the object approaches the sensing unit 21. Besides, the touch sensor, pressure sensor, micro switch, and the electronic sensor for sensing the variation of resistance, capacitance, inductance, voltage or static electricity are contact sensing components, which can generate the sensing signal S as the object touches the sensing unit 21. When the object approaches or touches the sensing unit 21, the sensing unit 21 generates the sensing signal S based on the variation of resistance, capacitance, inductance, static electricity, induced voltage, or magnetic or electric field. In more specific, the sensing unit 21 senses that an object approaches or touches the door handle, it can immediately generate a sensing signal S before the door handle is further moved or pulled. To be noted, the sensing unit 21 of the invention is not limited to any of the above-mentioned sensing components, and any component that can generate the sensing signal S once the object approaches or touches the door handle is applicable.

The control unit 22 receives the sensing signal S and then generates a control signal C. Preferably, the control unit 22 generates the control signal C according to a lock status of the car door. When the car door is locked, the control unit 22 does not generate the control signal C. In other words, when the object approaches or touches the door handle and intends to open the door, if the car door is in a lock status, the control unit 22 does not generate the control signal C. In other aspects, however, the control unit 22 may output other signals (not shown in FIG. 2) for reminding the driver or passengers. For example, when someone sitting on the rear seat intends to open the door and the car door is still in a lock status, the control unit 22 can control to output a notice signal by sound (dang-dang-dang) or light displayed on the instrument panel. This can remind the driver that somebody has tried to open the door or putted his/her hand on the door handle, so that the driver can immediately take the proper action. For example, the driver may unlock the door to allow the passenger to open the car door, or tell the passenger to unlock as well as reminding the safety procedures before open the car door.

When the control unit 22 receives the sensing signal S and the car door is unlocked, the control unit 22 generates the control signal C. Then, the warning unit 23 receives the control signal C and generates a warning signal W. In other words, when someone sitting on the rear seat intends to open the door and the car door is unlocked, the control unit 22 generates the control signal C and the warning unit 23 receives the control signal C so as to generates the warning signal W. The warning unit 23 may be installed inside the car (e.g. on the dashboard) and/or outside the car (e.g. on the car body, in the engine compartment, or on the chassis), and it may include a light emitting element, a speaker, a buzzer or their combinations. Besides, the warning signal W may include, for example but not limited to, sound, voice message, light or their combinations. For instance, the voice message may be “DOOR OPENING”, “BEWARE OF COMING TRAFFIC OR PEDESTRIAN WHEN EXIT”, or “BEWARE OF APPROACHING OBJECT”.

As mentioned above, the car door warning system 2 of the invention has a sensing unit 21 disposed at a door handle of at least one car door for generating a sensing signal S when the door handle is approached or touched by an object and before the door handle is moved. In addition, the control unit 22 receives the sensing signal S and generates a control signal C, preferably, according to a lock status of the car door, and the warning unit 23 generates a warning signal W after receiving the control signal C. Accordingly, before the door handle is moved or the car door is opened, it is possible to alert the driver or passengers that an object approaches or touches the door handle, thereby preventing the accident caused by opened car door.

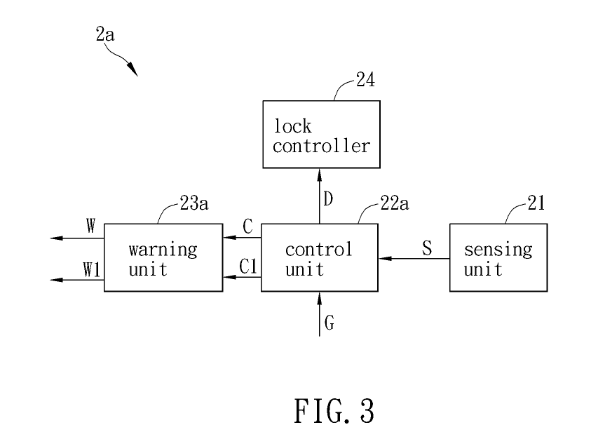

FIG. 3 is a block diagram of another car door warning system 2a according to the embodiment of the present invention.

Different from the car door warning system 2, the control unit 22a of the car door warning system 2a of FIG. 3 has an input terminal for receiving a status signal G from a device or apparatus. In more specific, the control unit 22a may receive the status signal G from the turn signal, reverse light, brake light (lighted on or not), supersonic range radar (for detecting whether an object is approaching or a barrier is around the car), speed detector (for detecting whether the car is running or totally stopped), or other devices or apparatuses. Thus, the control unit 22a can generate another control signal C1 according to the status signal G and the sensing signal S of the sensing unit 21. The warning unit 23a receives the control signal C1 and then generates another warning signal W1 for alerting or reminding the driver or passenger.

Furthermore, the control unit 22a may further include an output terminal for outputting a lock control signal D, which can control the lock/unlock or the door. In this embodiment, when the warning signal W is generated to indicate that it is dangerous to open the door (e.g. the car is still running), or when the warning signal W is not ended yet (e.g. the voice message is still broadcasting), it is possible to control the lock controller 24 to enforcedly lock the doors. In this case, even if the door handle is pulled, the car door can not be opened until continuously pulling the door handle for a period or after a preset period. This configuration can further protect the passengers from accident.

The technical features of other elements of the car door warning system 2a can be referred to those of the car door warning system 2, so the detailed descriptions thereof are omitted.

In summary, the car door warning system of the invention has a sensing unit disposed at a door handle of at least one car door for generating a sensing signal, when the door handle is approached or touched by an object, and before the door handle is moved. In addition, the control unit receives the sensing signal and generates a control signal, preferably, according to a lock status of the car door, and the warning unit generates a warning signal after receiving the control signal. Accordingly, before the door handle is moved or the car door is opened, it is possible to alert the driver or passengers when an object approaches or touches the door handle, thereby preventing the accident caused by the opened car door.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A car door warning system, comprising:
a sensing unit disposed at a door handle of at least one car door, wherein when the door handle is approached or touched by an object, the sensing unit generates a sensing signal before the door handle is moved;
a control unit receiving the sensing signal and generating a control signal; and
a warning unit receiving the control signal and generating a warning signal.

2. The warning system of claim 1, wherein the sensing unit comprises an electronic sensor, a touch sensor, an IR (infrared-ray) sensor, a supersonic sensor, a pressure sensor, a micro switch, a proximity sensor, or their combinations.

3. The warning system of claim 1, wherein the warning signal comprises sound, voice message, light or their combinations.

4. The warning system of claim 1, wherein the control unit further comprises an input terminal for receiving a status signal.

5. The warning system of claim 1 wherein the control unit further comprises an output terminal for outputting a lock control signal.
